(19) United States
(12) Patent Application Publication
(10) Pub. No.: US 2018/0208381 A1
(43) Pub. Date: Jul. 26, 2018

(54) Resealable Closure

(71) Applicant: Multi-Color Corporation, Batavia, OH (US)

(72) Inventors: Jeffrey A. Lesher, Reinholds, PA (US); Stephen J. Riccardi, York, PA (US); Philip A. Martinez, York, PA (US)

(21) Appl. No.: 15/410,957

(22) Filed: Jan. 20, 2017

(51) Int. Cl. B65D 75/58; G09F 3/02

(52) U.S. Cl. CPC B65D 75/5855; G09F 3/02; G09F 2003/0239; G09F 2003/0272; B65D 2575/586

(57) ABSTRACT

A resealable label includes a first section and a second section, the first section having a plurality of layers including at least a facestock layer and a first adhesive layer, and the second section having a plurality of layers including at least a base layer and a second adhesive layer. The first section is positioned relative to the second section such that the first adhesive layer and base layer are in confronting relationship with one another and are positioned between the facestock layer and the second adhesive layer. And the first section is positioned relative to the second section such that the first section extends beyond the second section such that at least a portion of the first adhesive layer is exposed and not in contact with any portion of the second section.

### FIELD OF THE INVENTION

The present invention relates to a resealable label that can be used to cover an opening in a product package, and be applied to the package such that the label can be repeatedly removed to access the articles contained within the package and then reapplied.

### BACKGROUND OF THE INVENTION

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

Resealable labels are commonly used with many different types of packages that contain (or are designed to contain) various products. One such package contains sheet-like removable articles that have been wetted with a liquid prior to packaging (i.e., moistened wipes). This type of package is generally constructed from a thin, flexible, liquid-impervious material that has an opening through which the articles may be removed. The resealable label is attached to the package such that the label (or at least a portion of the label—e.g., a label flap) is positioned over this opening. Often, the resealable label attached to the package is, or includes, a strip of flexible or semi-rigid material having a removable pressure-sensitive adhesive applied to one surface of the resealable label (or applied to one surface of a flap thereof). The removable adhesive creates a generally air-tight seal around the package opening to prevent the packaged removable articles from drying out during storage. During use, one grasps and pulls the label (or the flap) away from the opening in order to expose the opening in the package. An article or articles within the package may then be removed through the opening as desired. The resealable label (or the flap) may then be reattached over the opening, with the removable adhesive providing the seal.

In such packaging, as the articles are removed, a top surface of the flexible package may become deformed or waved (and the packages often do not include a rigid body). As a result, when an attempt is made to reattach the label (or flap thereof) to the package after opening, the label cannot be properly attached to the top of the package to create a seal around the package opening. Thus, it was thought desirable to use a more rigid material for the resealable label (or to use a more rigid material for a flap portion and incorporate a frame surrounding the flap)—and that the use of the more rigid material, and/or the use of such a frame would assist in maintaining the shape of the package better than conventional labels and/or flaps in order to ensure consistent proper sealing of the package.

One known container having a resealable label made of material which is stiffer than the container is set forth in U.S. Pat. No. 6,026,953 to Nakamura et al. The '953 patent discloses a single layer reinforcing sheet of between 100 and 130 micrometers having a cut line that defines a movable label flap with a starting tab. A crease is formed in the reinforcing sheet by the means of a press. The crease serves to define a hinge used in the opening and closing of the flap. The crease prevents the disengagement of the label flap from the reinforcing sheet. One problem with this approach is that creases in stiff, rigid materials do not form good hinges. A hard crease will create a hinge that bends easily, but the material tends to break at the hinge. A soft crease will create a hinge that bends hard, and resists bending back on reclosure of the label flap. Further, in general, bending a more rigid, pivotally secured label flap to access the opening in a package is more difficult than the use of a more flexible label flap.

Another known closure that can be used as a resealable label, and which is made of a material that is stiffer than the container, is described in U.S. Pat. No. 8,182,891 to Scott et al. The '891 patent describes a label flap including a base layer having a first adhesive on a bottom face surface that permits repeated application and separation of the base layer relative to the package. A top layer is attached to and coextensive with the base layer and includes a second adhesive on a bottom face surface that permanently attaches the top layer to a top face surface of the base layer. The base layer and the first adhesive on the bottom face surface thereof are formed with a slit that defines a hinge for facilitating separation of the base and top layers from the package upon manipulation of a starting tab.

However, the resealable label of the type shown in the '891 patent also suffers drawbacks. First, the design of that resealable label requires a perimeter of material surrounding the flap portion of the label, the flap portion being that part of the label that is grasped and moved to expose the opening in the package and then resealed (i.e., the label of the '891 patent incorporates a frame surrounding the flap, as described above). Because a slit is used in creating the hinge of the label, this additional material along the edges (i.e., the frame) is needed to prevent the label flap from lifting off, and being completely removed from, the package if pulled with too much force. The use of additional materials to make these rigid resealable labels results in an increase in the overall cost of the labels.

Second, the use of the additional material results in the resealable label (of the type described in the '891 patent) having a larger overall footprint than other labels. Due to (1) this larger footprint, coupled with (2) the tolerances of side to side movement when labels are applied on a packaging line, labels of the type disclosed in the '891 patent have been applied with at least one edge of the label (typically the long dimension edge) extending past the edge of the package itself. In use, a consumer grasps the package in their palm and wraps their fingers over the edges of the package. When the label extends over the edge of the package, the consumer is at risk of a laceration as a result of the edge of the label coming into contact with the consumer's fingers.

### SUMMARY OF THE INVENTION

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

The resealable label described herein overcomes the drawbacks of the prior art described above. More specifically, aspects of the present invention provide a resealable label that has a degree of rigidity to result in a proper seal over an opening in a package to which it is applied, that uses less material (and thus is of lower cost) than the prior art described above, and which reduces and/or eliminates the issue of possible injury to users/consumers from the label.

In doing so, one embodiment of the resealable label includes a first section and a second section. The first section includes a plurality of layers, that plurality of layers including at least a facestock layer and a first adhesive layer; and the second section includes a plurality of layers, that plurality of layers including at least a base layer and a second adhesive layer. The first section is positioned relative to the second section such that the first adhesive layer and base layer are positioned between the facestock layer and the second adhesive layer (such that they are in confronting relationship with one another—whether or not there may be intervening layers therebetween). Further, the first section is positioned relative to the second section such that a portion of the first section extends beyond the second section such that at least a portion of the first adhesive layer is exposed and not in contact with any portion of the second section.

In a more specific embodiment, the resealable label may include additional layers such that one embodiment of the resealable label includes: (1) a top layer, (2) a first ink layer, (3) a facestock layer, (4) a first adhesive layer, (5) a second ink layer, (6) a base layer, and (7) a second adhesive layer. The first section includes the first four layers (top layer, first ink layer, facestock layer, and first adhesive layer) and the second section includes the remaining three layers (second ink layer, base layer, and second adhesive layer). The first section is positioned relative to the second section such that a portion of the first section extends beyond the second section such that at least a portion of the first adhesive layer is not in contact with any portion of the second section.

The resealable label may be applied to a package such that it overlies an opening in the package. The extended portion of the first section (i.e., that portion that does not overlie the second section) allows a first adhesive of the first adhesive layer to be exposed for adhering of the resealable label to the package to which it is applied. And the second section then overlies any opening in such package to form a seal thereover.

In use, the resealable label is grasped at a first end thereof, the first end being opposite a second end that is adhered to a package, and peeled back to expose the opening in the container to allow a user to access an article or articles within the package. The first adhesive bonded to the container at the extended first section of the resealable label prevents the resealable label from being completely removed from the container. And the removable and resealable adhesive at the bottom of the second section allows the label to be reapplied and resealed to the container to protect the contents therein.

Further, the use of the extended portion (and thus, the elimination of any slit to form a hinge) in the various embodiments means that no extra materials for a frame are required to provide extra support to the hinge area to prevent its inadvertent removal from the package. This results in the use of less material, and a reduction in cost of the package (while still using materials that provide the desired rigidity). And, the elimination of excess materials also results in a smaller dimension of the present resealable label as compared to the rigid labels of the prior art—which, in turn, results in the application of the label to packages without any overhang of edges, which could result in injury to a user.

### BRIEF DESCRIPTION OF THE DRAWINGS

The accompanying drawings, which are incorporated in and constitute a part of this specification, illustrate embodiments of the invention and, together with the general description of the invention given above and the detailed description of the embodiments given below, serve to explain the principles of the present invention.

FIG. 1 is a perspective view of a product package including a resealable label in accordance with the principles of embodiments of the present invention, depicting the resealable label in a closed position over the opening of the package.

FIG. 2 is a perspective view of a product package including a resealable label in accordance with the principles of embodiments of the present invention, depicting the resealable label being lifted away from the opening of the package.

FIG. 3 is a cross-sectional view of one embodiment of a resealable label in accordance with the principles of the present invention, depicting the resealable label in a closed position over the opening of the package.

FIG. 4 is a cross-sectional view of the embodiment of the resealable label of FIG. 3 in accordance with the principles of the present invention, depicting the resealable label being lifted away from the opening of the package.

FIG. 5 is a cross-sectional view of another embodiment of a resealable label in accordance with the principles of the present invention, depicting the resealable label in a closed position over the opening of the package.

FIG. 6 is a cross-sectional view of the embodiment of the resealable label of FIG. 5 in accordance with the principles of the present invention, depicting the resealable label being lifted away from the opening of the package.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

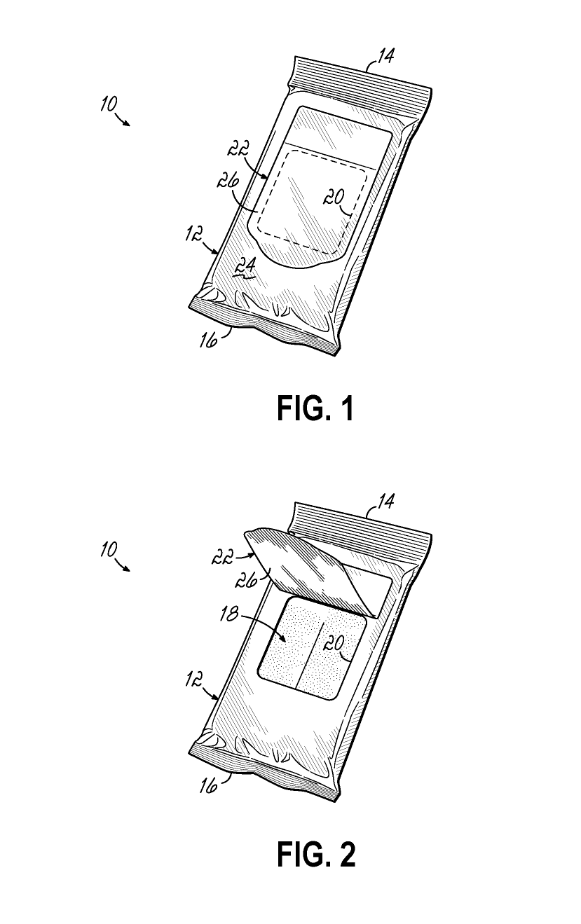

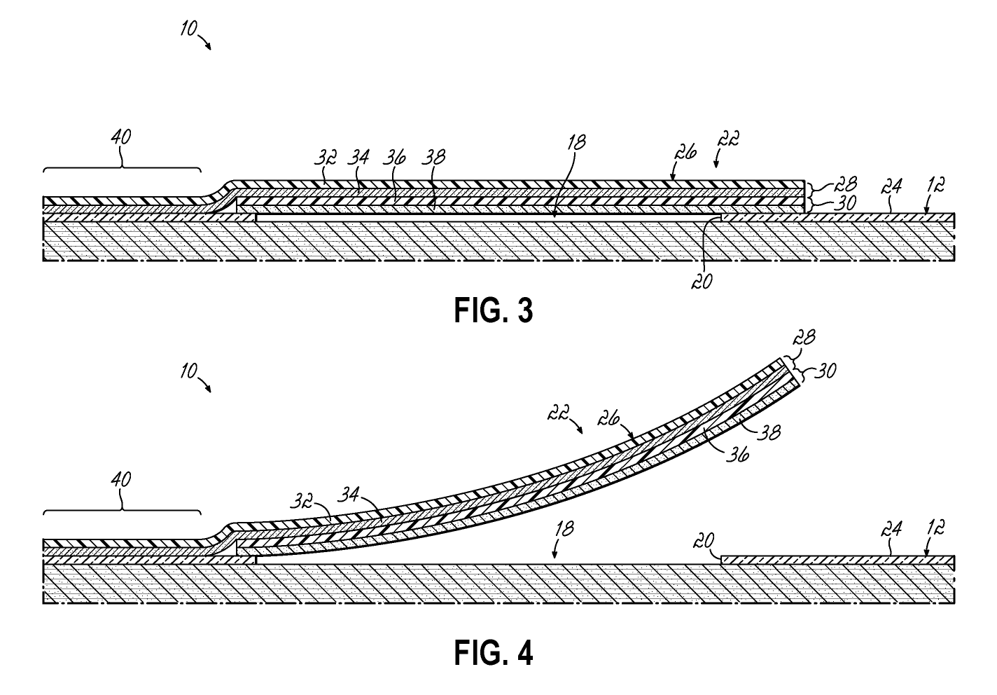

As described above, the environment in which a resealable label is typically used is in association with a package that can contain various articles. FIGS. 1 and 2 generally illustrate a such a package 10 having a main package body 12 formed by a liquid-impervious, flexible, material sealed on each end 14, 16 to define an internal space 18 (shown in FIGS. 3-6) for housing removable articles that are contained within the package 10. For example, the contents of the package 10 may include a series of stacked, individual cleaning cloths that can be impregnated by appropriate cleaning solutions. Although a specific type and shape of package 10 is shown in the Figures, other types of packages for containing other types of products are possible for use with the resealable label described herein.

Still referring to FIGS. 1 and 2, the package body 12 includes an opening 20 through the package body 12 to provide access into the internal space 18 of the package body 12 containing the articles. As can be readily understood, the individual products contained in the product package 10 can be removed from the internal space 18 defined by the package body 12 through the opening 20.

The package 10 further includes a resealable label 22 that is applied to the package body 12 to seal the package body 12 by covering the opening 20. The label 22 contacts the generally smooth, flat top surface 24 of the package body 12, and forms a generally water and air-tight seal with the package body 12 around the opening 20. The water and air-tight seal around the opening 20 prevents contamination of the articles, and in embodiments where the articles are wet or moistened, prevents the articles from drying out. The resealable label 22 is attached to the upper surface of the package body 12 such that a flap portion 26 of the label 22 can be repeatedly opened and resealed to provide access to the articles contained within the internal space 18 defined by the package body 12.

The resealable label 22 described herein overcomes the drawbacks of the prior art described above. More specifically, aspects of the present invention provide a resealable label that has a degree of rigidity to result in a proper seal over an opening in a package to which it is applied, that uses less material (and thus is of lower cost) than the prior art described above, and which reduces and/or eliminates the issue of possible injury to users/consumers due to the label.

In doing so, and referring now to FIGS. 3 and 4, one embodiment of the resealable label 22 includes a first section 28 and a second section 30. The first section 28 includes a plurality of layers, that plurality of layers including at least a facestock layer 32 and a first adhesive layer 34; and the second section 30 includes a plurality of layers, that plurality of layers including at least a base layer 36 and a second adhesive layer 38. The first section 28 is positioned relative to the second section 30 such that the first adhesive layer 34 and base layer 36 are positioned between the facestock layer 32 and the second adhesive layer 38 (such that they are in confronting relationship with one another—whether or not there may be intervening layers therebetween). Further, the first section 28 is positioned relative to the second section 30 such that a portion 40 of the first section 28 extends beyond the second section 30 such that at least a portion of the first adhesive layer 34 is not in contact with any portion of the second section 30.

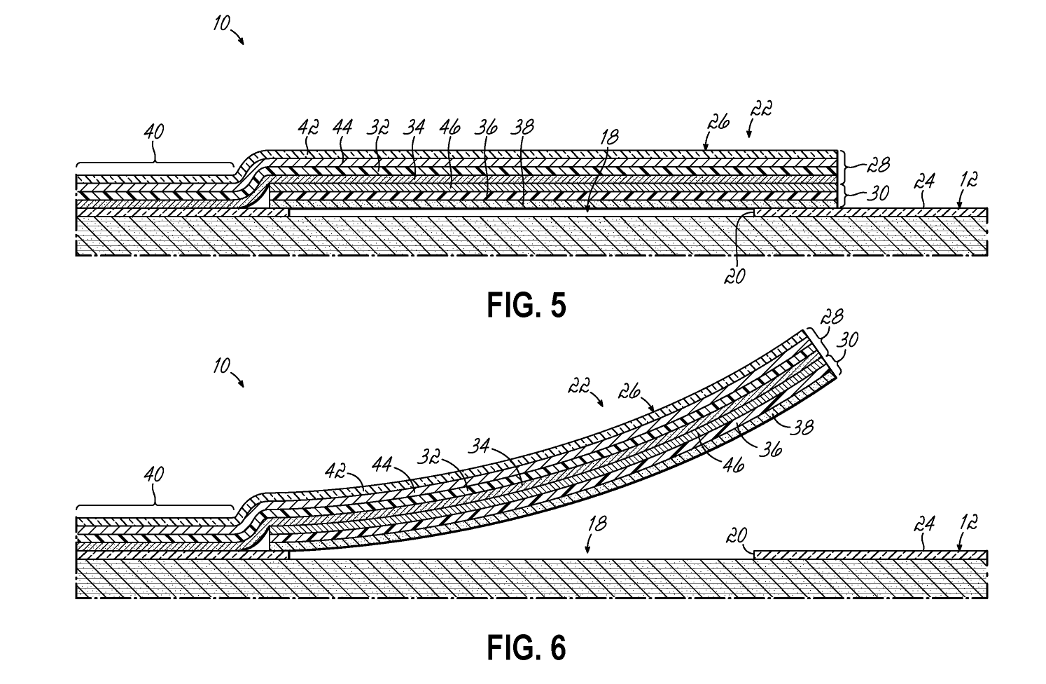

Further, and referring now to FIGS. 5 and 6, the resealable label 22 may include additional layers such that one embodiment of the resealable label 22 includes: (1) a top layer 42, (2) a first ink layer 44, (3) a facestock layer 32, (4) a first adhesive layer 34, (5) a second ink layer 46, (6) a base layer 36, and (7) a second adhesive layer 38. The first section 28 of this embodiment includes the first four layers (top layer 42, first ink layer 44, facestock layer 32, and first adhesive layer 34) and the second section 30 includes the remaining three layers (second ink layer 46, base layer 36, and second adhesive layer 38). The first section 28 is positioned relative to the second section 30 such that a portion 40 of the first section 28 extends beyond the second section 30 such that at least a portion of the first adhesive layer 34 is exposed and not in contact with any portion of the second section 30.

The use of the extended portion 40 (and thus, the elimination of any slit to form a hinge) in the various embodiments means that no extra materials for a frame are required to provide extra support to a hinge area to prevent inadvertent removal of the resealable label 22 from the package 10. This results in the use of less material, and a reduction in cost of the package 10 (while still using materials that provide the desired rigidity). And, the elimination of excess materials also results in a smaller dimension of the present resealable label 22 as compared to the rigid labels of the prior art—which, in turn, results in the application of the label 22 to packages without any overhang of edges, which could result in injury to a user.

As described above, the resealable layer includes a facestock layer 32. In general, the facestock may comprise a material such as those that would typically be used as facestock in a pressure-sensitive label. In one embodiment, the facestock layer 32 may include a polyolefin film. And such polyolefin film may be clear or opaque in certain embodiments. An example of such a polyolefin film is a Primax® film, commercially available from Avery Dennison Corporation of Pasadena, Calif. The polyolefin film of the facestock layer 32, in certain embodiments of the invention may have a thickness in the range of 0.0015″ to 0.004″.

As described above, the resealable layer includes a first adhesive layer 34. In one particular embodiment, the first adhesive layer 34 includes a permanent adhesive. In use, this permanent adhesive, which is exposed in the extended portion 40 of the first section 28 beyond the second section 30 of the resealable label 22, may allow for permanent bonding of the resealable label 22 to a package 10 to form a resealable package 10. “Permanent,” as understood by those of skill in the art (and as used herein), provides a bonding strength between the resealable label 22 and the product package 10 that is greater than the typical force that would be applied to the flap portion 26 of the label 22 to lift and remove that flap portion 26 to expose the opening 20 in the product package 10. Such a permanent adhesive may include an acrylic adhesive. One example of a acrylic adhesive suitable for the resealable label 22 is Fasson® S730 adhesive, commercially available from Avery Dennison Corporation of Pasadena, Calif. However, it will be recognized by those of ordinary skill in the art that the properties of the permanent adhesive—and thus the particular adhesive used—may be dictated at least by both the construction of the package being sealed (i.e., the material of the package body 12 that the permanent adhesive will have to bond to) as well as the chemical makeup of the articles contained in the package 10. The acrylic adhesive of the first adhesive layer 34, in certain embodiments of the invention may have a thickness in the range of 0.0005″ to 0.0015″.

Further, as can be seen in FIGS. 3-6, while a portion of the first adhesive layer 34 is in the extended portion 40 of the first section 28 (and is used to bond the resealable label 22 to the package 10), another portion of the first adhesive layer 34 bonds the first section 28 of the resealable label 22 to the second section 30 of the resealable label 22.

Additionally, as described above, the resealable label 22 may include a first ink layer 44 in the first section 28, the first ink layer 44 positioned such that the facestock layer 32 is between the first ink layer 44 and the first adhesive layer 34. The first ink layer 44 may include one or more inks to form indicia of the label 22 (such as graphics, text, designs, etc.), and may be selected based on the particular needs of the label 22 or the particular indicia to be printed on the label 22. Thus, any inks could be suitable for the first ink layer 44, including but not limited to water based inks, solvent based inks, energy curable inks, flexo screen inks, and offset inks. The selection of such inks is within the knowledge of those of ordinary skill in the art.

The resealable label 22 may also include a top layer 42 disposed adjacent the first ink layer 44 such that the first ink layer 44 is positioned between the top layer 42 and the facestock layer 32. The top layer 42 may be chosen from a film and a varnish. In one embodiment, the top layer 42 may include biaxially oriented polypropylene (BOPP)—i.e., a polypropylene film extruded and stretched in both the machine direction and across machine direction. Additionally, the top layer 42 may be of a clear material (which allows the indicia of the inks of the label 22 to be viewed. In another embodiment, the film of the top layer may be a clear polyester (PET) film. One such film is 600T Thermal Transfer Printable Polyester Overlaminate, commercially available from ACPO, Ltd., of Oak Harbor, Ohio. The top layer 42, in certain embodiments of the invention may have a thickness in the range of 0.0005″ to 0.002″.

The resealable label 22 may also include a second ink layer 46 in the second section 30, the second ink layer 46 positioned such that the base layer 36 is between the second ink layer 46 and the second adhesive layer 38. The second ink layer 46 may be used to provide indicia, and if so, the second ink layer 46 may include one or more inks to form graphics, text, designs, etc., and may be selected based on the particular needs of the label 22 or the particular indicia to be printed on the label 22. Thus, any inks could be suitable for the second ink layer 46, including but not limited to water based inks, solvent based inks, energy curable inks, flexo screen inks, and offset inks. The selection of such inks is within the knowledge of those of ordinary skill in the art.

The resealable label 22 may also include a deadener to assist a user in lifting the label 22, or flap portion 26 thereof, away from the package body 12. In one example of an embodiment, the deadener may be a UV cured coating that creates a solid layer between the releasable and resealable adhesive of the second adhesive layer 38 and a user's finger. The coating creates a peel tab, and makes it easier for users to open the package 10. The deadener may be a portion of the second ink layer 46, and may include a UV cured ink.

In one embodiment, the base layer 36 may be a layer including polystyrene (or may be a polystyrene layer). In particular, the base layer 36 may include a polystyrene film. An example of a polystyrene film that is suitable for various embodiments of the present invention is Tekra 250 Micron Polystyrene, commercially available from Tekra, a division of EIS, Inc., of New Berlin, Wis. The base layer 36, in certain embodiments of the invention may have a thickness in the range of 0.004″ to 0.012″. However, it should be understood that the thickness of the polystyrene can vary depending on the stiffness desired. In alternate embodiments, another material (or materials) may be used for the base layer 36. Such materials may include polyester and/or polypropylene.

As described above, the resealable label 22 includes a second adhesive layer 38. In one particular embodiment, the second adhesive layer 38 includes a releasable and resealable adhesive. In use, this releasable and resealable adhesive, as understood by those of skill in the art, provides a bonding strength between the resealable label 22 and the product package 10 that allows force to be applied to the flap portion 26 of the label 22 to lift and remove that flap portion 26 to expose the opening 20 in the product package 10, and then to be able to seal to the product package 10 once it is returned to contact with the product package surface. Such a releasable and resealable adhesive may include a releasable and resealable acrylic adhesive. An example of a releasable and resealable acrylic adhesive is Fasson® R3500 (an acrylic adhesive designed for ease of removability), commercially available from Avery Dennison Corporation of Pasadena, Calif.

However, it will be recognized by those of ordinary skill in the art that the properties of the releasable and resealable adhesive—and thus the particular adhesive used—may be dictated at least by both the construction of the package being sealed (i.e., the material of the package body 12 that the releasable and resealable adhesive will have to bond to) as well as the chemical makeup of the articles contained in the package 10. The releasable and resealable adhesive of the second adhesive layer 38, in certain embodiments of the invention may have a thickness in the range of 0.0005″ to 0.0015″.

The resealable label 22 may also include a carrier adjacent to the releaseable and resealable adhesive of the second adhesive layer 38. The carrier may be chosen from paper and a silicon coated PET film. During application of the resealable label 22 to a package 10, the carrier will be removed from the resealable label 22, thereby allowing first and second adhesives to be exposed in order to apply the resealable label 22 to a package 10.

More specifically, the resealable label 22 may be applied to a package 10 such that it overlies an opening 20 in the package 10. The extended portion 40 of the first section 28 (i.e., that portion 40 that does not overlie the second section 30) allows a first adhesive of the first adhesive layer 34 to be exposed for adhering of the resealable label 22 to the package 10 to which it is applied. And the second section 30 then overlies any opening 20 in such package 10 to form a seal thereover.

In use, the resealable label 22 is grasped at an end opposite the end that is adhered to a package 10. Once grasped, the user pulls back on the label 22 (or any flap portion 26 thereof) to overcome the adhesive bond between the releasable and resealable adhesive of the second adhesive layer 38 and the package body 12. The user may continue to pull back on the label 22 (or flap portion 26) causing the label 22 to be pulled out of contact with the package body 12 adjacent to the opening 20 in the package body 12. This exposes the opening 20 in the package 10 to allow a user to access the article or articles within the package 10. Upon reaching the edge of overlap between the first section 28 and the second section 30, the base layer 36 and underlying second adhesive layer 38 may be fully separated from the upper surface of the package 10. However, removal or disengagement of the entire label 22 from the package 10 is prevented because of the portion 40 of the first section 28 of the label 22 that is bonded to the package 10 via the first adhesive layer 34. As a result, easy bending occurs along the edge of overlap between the first section 28 and the second section 30 of the label 22. Once the label 22 has been peeled back, and the opening 20 exposed, the user may access articles from the package 10.

After the desired number of articles have been removed from the opening 20, the user may reposition the label 22 over the opening 20. The second adhesive layer 38 reseals the label 22 onto the package body 12 over the opening 20 to form the seal around the opening 20.

The embodiments of the present invention recited herein are intended to be merely exemplary and those skilled in the art will be able to make numerous variations and modifications to it without departing from the spirit of the present invention. Notwithstanding the above, certain variations and modifications, while producing less than optimal results, may still produce satisfactory results. All such variations and modifications are intended to be within the scope of the present invention as defined by the claims appended hereto.

What is claimed is:

1. A resealable label comprising:
a first section and a second section, the first section comprising a plurality of layers, the plurality of layers of the first section including at least a facestock layer and a first adhesive layer, and the second section comprising a plurality of layers, the plurality of layers of the second section including at least a base layer and a second adhesive layer;
wherein the first section is positioned relative to the second section such that the first adhesive layer and base layer are in confronting relationship with one another and are positioned between the facestock layer and the second adhesive layer; and
wherein the first section is positioned relative to the second section such that the first section extends beyond the second section such that at least a portion of the first adhesive layer is not in contact with any portion of the second section.

2. The resealable label of claim 1, wherein the facestock layer includes a pressure-sensitive facestock.

3. The resealable label of claim 2, wherein the pressure-sensitive facestock includes a polyolefin film.

4. The resealable label of claim 1, wherein the facestock layer has a thickness in the range of about 0.0015″ to about 0.004″.

5. The resealable label of claim 1, further comprising a first ink layer in the first section, the first ink layer positioned such that the facestock layer is between the first ink layer and the first adhesive layer.

6. The resealable label of claim 5, further comprising a top layer disposed adjacent the first ink layer such that the first ink layer is positioned between the top layer and the facestock layer.

7. The resealable label of claim 5, wherein the first ink layer includes at least one ink chosen from a water based ink, a solvent based ink, an energy curable ink, a flexo screen ink, and an offset ink.

8. The resealable label of claim 6, wherein the top layer includes a material chosen from a film and a varnish.

9. The resealable label of claim 8, wherein the top layer is a film and includes biaxially oriented polypropylene.

10. The resealable label of claim 8, wherein the top layer has a thickness in the range of about 0.0005″ to about 0.002″.

11. The resealable label of claim 1, wherein the first adhesive layer includes a permanent adhesive.

12. The resealable label of claim 11, wherein the permanent adhesive includes an acrylic adhesive.

13. The resealable label of claim 11, wherein the first adhesive layer has a thickness in the range of about 0.0005″ to about 0.0015″.

14. The resealable label of claim 5, further comprising a second ink layer in the second section, the second ink layer positioned such that the base layer is between the second ink layer and the second adhesive layer.

15. The resealable label of claim 14, wherein the second ink layer includes at least one ink chosen from a water based ink, a solvent based ink, an energy curable ink, a flexo screen ink, and an offset ink.

16. The resealable label of claim 1, wherein the base layer includes polystyrene.

17. The resealable label of claim 1, wherein the base layer has a thickness in the range of about 0.004″ to about 0.012″.

18. The resealable label of claim 1, wherein the second adhesive layer includes a releasable and resealable adhesive.

19. The resealable label of claim 18, wherein the releasable and resealable adhesive may include an acrylic adhesive.

20. The resealable label of claim 18, wherein the second adhesive layer has a thickness in the range of about 0.0005″ to about 0.0015″.

21. A resealable package comprising:
a package body having an internal space sized to contain a plurality of removable articles;
an opening through the package body to the internal space for accessing the removable articles; and
a resealable label positioned on the package and having a portion capable of being positioned to cover the opening in the package, the resealable label including:
a first section and a second section, the first section comprising a plurality of layers, the plurality of layers of the first section including at least a facestock layer and a first adhesive layer, and the second section comprising a plurality of layers, the plurality of layers of the second section including at least a base layer and a second adhesive layer;
wherein the first section is positioned relative to the second section such that the first adhesive layer and base layer are in confronting relationship with one another and are positioned between the facestock layer and the second adhesive layer; and
wherein the first section is positioned relative to the second section such that the first section extends beyond the second section such that at least a portion of the first adhesive layer is not in contact with any portion of the second section.
